(19) United States
(12) Patent Application Publication
(10) Pub. No.: US 2026/0268890 A1
(43) Pub. Date: Sep. 10, 2026

(54) AUDIO CONTENT GENERATION FOR AGENTIC AI SYSTEMS AND APPLICATIONS

(71) Applicant: NVIDIA Corporation, Santa Clara, CA (US)

(72) Inventors: Francesco Ciannella, San Francisco, CA (US); Davide Marco Onofrio, San Francisco, CA (US); Jose Rafael Valle Gomes da Costa, Berkeley, CA (US)

(21) Appl. No.: 19/075,605

(22) Filed: Mar. 10, 2025

(51) Int. Cl. G10L 13/08; G10L 25/63

(52) U.S. Cl. CPC G10L 13/08; G10L 25/63

(57) ABSTRACT

In various examples, techniques for audio and/or other content generation for agentic AI systems and applications are described herein. Systems and methods described herein may use inputted information-such as a topic, a number of characters, roles for the characters, identities of the characters, a number of scenes, a plain language description, and/or the like-to generate a conversation between characters. For instance, a screenwriter agent may process the inputted information to generate a script associated with the conversation. A director agent may then use the script to manage the performance of the conversation, such as by controlling the dialogue between character agents. For instance, the character agents may generate speech corresponding to different scenes of the conversation as provided by the director agent, where the character agents may use voice cloning to cause the voices of the characters to sound realistic, human, and/or emotional.

### BACKGROUND

Generating conversations between artificial intelligence (AI) characters—such as in the form of debates, podcasts, discussions, reviews, and/or the like—requires a significant amount of time, coordination, and resources. For instance, conventional systems that provide AI conversations use scripted dialogues that are generated using basic AI models along with text-to-speech (TTS) models that then process the text from the scripted dialogues to generate corresponding speech for characters. However, by using such techniques, these conventional systems provide scripted robotic-sounding voices for the characters which lack the nuance of human speech while also being limited in the ability to maintain coherent and engaging conversations on topics. Additionally, these conventional systems lack the ability to allow for human guidance during content generation, which results in less relevant and/or off-topic discussions.

### SUMMARY

Embodiments of the present disclosure relate to audio content generation for agentic AI systems and applications. Systems and methods described herein may use inputted information-such as a topic, a number of characters, roles for the characters, identities of the characters, a number of scenes, text, audio, video data, a plain language description, and/or the like-to generate a conversation between characters. For instance, a screenwriter agent may use one or more language models that process the inputted information and generate a script associated with the conversation. A director agent may then use the script to manage the performance of the conversation, such as by controlling the dialogue between character agents. For instance, the character agents may use one or more models—such as the language model(s), one or more TTS models, and/or the like—along with additional inputs—such as personality profiles—to generate speech corresponding to different scenes of the conversation as provided by the director agent. As described in more detail herein, in some examples, the systems and methods may use additional techniques to improve the performance of the conversation, such as voice cloning and emotion recognition models to cause the voices of the characters to sound realistic, human, and/or emotional.

In contrast to conventional systems, the systems of the present disclosure, in some embodiments, allow for directional input for topic steering (e.g., the inputted information) to guide the conversation such that the content remains relevant while also allowing for real-time adjustments, oversight, and quality control of the conversation. Additionally, by using the language model(s) to generate the content (e.g., the script, the speech, etc.) associated with the conversation, the systems of the present disclosure are scalable across any number of topics allowing for a vast and diverse range of content that may be produced on demand. Furthermore, the systems of the present disclosure support multiple characters (e.g., actors) along with moderators (e.g., the screenwriter, the director, etc.) for complex, multi-perspective conversations that create more realistic conversations. Moreover, the systems of the present disclosure, in some embodiments, may perform voice cloning with regard to the characters to produce audio content that sounds like real, human voices, which enhances the authenticity and engagement level of the conversation.

### BRIEF DESCRIPTION OF THE DRAWINGS

The present systems and methods for audio content generation for agentic AI systems and applications are described in detail below with reference to the attached drawing figures, wherein:

FIG. 1 illustrates an example data flow diagram for a process for generating audio content associated with conversations between AI agents, in accordance with some embodiments of the present disclosure;

FIG. 2 illustrates an example of a user inputting information for creating a conversation between characters, in accordance with some embodiments of the present disclosure;

FIG. 3 illustrates an example of generating character profiles associated with characters that may be included in a conversation, in accordance with some embodiments of the present disclosure;

FIG. 4 illustrates an example of a script associated with a conversation between characters, in accordance with some embodiments of the present disclosure;

FIG. 5 illustrates an example of a director agent using a script to manage a conversation between characters, in accordance with some embodiments of the present disclosure;

FIG. 6 illustrates a first example of using voice cloning to generate speech associated with a conversation between characters, in accordance with some embodiments of the present disclosure;

FIG. 7 illustrates an example of generating voice data representing a voice that is expressed using different emotions, in accordance with some embodiments of the present disclosure;

FIGS. 8A-8B illustrate a second example of using voice cloning to generate speech associated with a conversation between characters, in accordance with some embodiments of the present disclosure.

FIG. 9 illustrates an example of verifying that speech to be output by a character reflects a scene of a conversation, in accordance with some embodiments of the present disclosure;

FIG. 10 illustrates an example of one or more systems that may use one or more of the processes described herein to generate conversations, in accordance with some embodiments of the present disclosure;

FIG. 11 illustrates a flow diagram showing a method for generating audio content associated with a conversation between characters, in accordance with some embodiments of the present disclosure;

FIG. 12 illustrates a flow diagram showing a method for generating a conversation using voice cloning for characters, in accordance with some embodiments of the present disclosure;

FIG. 13A is a block diagram of an example generative language model system suitable for use in implementing at least some embodiments of the present disclosure;

FIG. 13B is a block diagram of an example generative language model that includes a transformer encoder-decoder suitable for use in implementing at least some embodiments of the present disclosure;

FIG. 13C is a block diagram of an example generative language model that includes a decoder-only transformer architecture suitable for use in implementing at least some embodiments of the present disclosure;

FIG. 14 is a block diagram of an example computing device suitable for use in implementing some embodiments of the present disclosure; and

FIG. 15 is a block diagram of an example data center suitable for use in implementing some embodiments of the present disclosure.

### DETAILED DESCRIPTION

Systems and methods are disclosed for audio content generation for agentic AI systems and applications. For instance, a system(s) may generate profiles—such as personality profiles, language profiles, and/or the like—for characters that may participate in conversations. To generate a profile associated with a character, the system(s) may apply, to one or more language models, input data representing one or more resources that include information related to the character and/or one or more prompts for retrieving the portions of information associated with the profile. As described herein, a resource may include, but is not limited to, a webpage, a book, a biography, a manuscript, a document, an article, notes, and/or any other type of resource that may include information related to a character. Additionally, the prompt(s) may be associated with the type of information needed for generating the profile.

For a first example, if the system(s) is generating a language profile associated with the character, then a prompt may be associated with retrieving and/or generating information related to a speech pattern, a tone, a dialect, an accent, a communication style, an emotional expression, and/or any other language information associated with the character. For a second example, if the system(s) is generating a personality profile associated with the character, then a prompt may be associated with retrieving and/or generating information related to personality traits, behavioral patterns, emotional characteristics, motivations, features, interpersonal relations, conflict resolution, an age, a zodiac sign, and/or any other personality information associated with the character. In either of the examples, the language model(s) may process the input data and, based at least on the processing, output the requested information. The system(s) may then use the information to generate the profile(s) associated with the character and store the profile(s) in one or more databases. Additionally, the system(s) may perform similar processes to generate and/or store one or more additional profiles associated with one or more additional characters.

The system(s) may also generate and/or store, in the database(s), voice profiles that include at least voice data representing voices for one or more characters. For instance, and for a voice profile, the system(s) may store audio data representing speech associated with a voice, such as a five second clip (and/or any other length clip) of the speech. As described herein, the speech may include actual user speech from a character—such as when the character is based on a real person—or the speech may include user speech from a human and/or synthetic speech for a virtual character that is not based on a real person.

Additionally, in some examples, for a voice profile, the system(s) may generate and/or store audio data representing instances of speech that are associated with different emotions for a voice, such as happy, mad, sad, surprised, scared, and/or any other emotion. For a first example, the system(s) may receive instances of audio data representing a character speaking using the different emotions. For a second example, and as described in more detail herein, the system(s) may use audio data representing speech associated with a character, along with audio data representing instances of speech associated with different emotions from one or more other characters, to generate the instances of audio data representing the speech associated with a voice expressed using different emotions.

The system(s) may then generate and provide content related to a conversation between characters, such as a debate, a podcast, a discussion, a review, and/or any other type of conversation. For instance, the system(s) may receive input data representing information for creating a conversation. As described herein, the information may include, but is not limited to, one or more topics, a number of characters, identities of the characters, the profiles associated with the characters, roles of the characters, a number of scenes, text, audio, video data, a plain language description, one or more time thresholds for one or more of the scenes, and/or any other information that may be used to create the conversation. The system(s) may then use a first agent, which may also be referred to as the “screenwriter agent,” to generate a script using the inputted information and/or one or more prompts that provide instructions associated with generating the script. For instance, the screenwriter agent may apply input data representing at least the inputted information and/or the prompt(s) to the language model(s) which processes the input data and generates the script associated with the conversation.

In some examples, the script may include the number of scenes, where an individual scene includes information and/or details for generating content related to the conversation. For instance, a scene may include at least an initial description related to what should occur during the scene, key instructions on how the scene should proceed, a duration threshold, and/or any other information. For example, an initial description for a scene may indicate that a first character is to introduce a second character. Additionally, key instructions for the scene may indicate that the first character uses humor to perform the introduction, the first character does not directly interact with the second character during the introduction, and the introduction ends with a fun remark describing the second character.

The system(s) may then use a second agent, which may also be referred to as the “director agent,” to manage the conversation using at least the script. For instance, the director agent may be configured to at least provide third agents, which may be referred to as the “character agents” since they control the speech of the characters, with information for generating the speech. For a first example, individual scenes from the script may be associated with different characters that are set to interact during the individual scenes. As such, the director agent may provide first information related to a first scene to a character agent that is supposed speak during the first scene, followed by second information related to a second scene to a character agent that is supposed to speak during the second scene, and/or so forth. For a second example, individual scenes from the script may be associated with multiple characters that are set to interact during the individual scenes. As such, the director agent may provide information related to a scene to multiple character agents that are supposed to speak during the scene. As described herein, information provided to a character agent may include, but is not limited to, one or more questions, instructions, details, emotions, past transcripts, profiles, and/or the like that may be used to generate speech.

For instance, to generate speech, a character agent may input data representing at least the information and/or one or more prompts into the language model(s) which processes the input data and generates text—such as a transcript of a response—related to the speech to be output by the character. In some examples, the character agent and/or another agent may then analyze the text to determine whether the transcript is reflective of the scene. For example, the character agent and/or the other agent may determine that the transcript is reflective of the scene when the transcript complies with the instructions provided to the character agent. If it is determined that the transcript is not reflective of the scene, then the character agent may again use the input data and/or additional data representing one or more reasons why the transcript does not reflect to the scene to generate new text, such as a new transcript of a new response. This process may then continue to repeat until the character agent and/or the other agent determines that a transcript accurately reflects the scene.

The character agent may then use one or more TTS models to process the text and generate audio data representing speech corresponding to the transcript. As described herein, the character agent may use voice cloning to generate the speech in a voice that is associated with the character. For example, the character agent may use the voice profile associated with the character to generate the speech in the voice associated with the character. Additionally, in some examples, the character agent may generate the speech to represent one or more emotions associated with the character. For a first example, if an entirety of the speech is associated with a single emotion, then the character agent may use the stored audio data representing the stored speech in the emotion, from the voice profile, to generate the audio data representing the speech in the voice associated with the character as expressed using the emotion. For a second example, if the speech is associated with multiple emotions, then the character agent may use the stored audio data representing the stored instances of speech expressed using the multiple emotions to generate the audio data representing the speech in the voice associated with the character as expressed using the multiple emotions. For instance, the character agent may generate the speech such that individual portions of the speech (e.g., words, sentences, paragraphs, etc.) are expressed using different emotions.

In some examples, the character agent may generate the audio data to represent one or more other sounds either made by the character and/or from an environment for which the character is configured to be located. For a first example, the character agent may generate the audio data to further represent the sounds other than speech from the character, such as the character coughing, laughing, and/or the like. For a second example, the character agent may generate the audio data to represent sounds within the surrounding environment like weather, the shuffling of papers, the moving of desk objects, and/or the like. In other words, the character agent may generate the audio data to represent both sounds from the character along with sounds from the surrounding environment.

In some examples, these processes may then continue to repeat where the director agent provides information associated with scenes to the character agents which then use the information to generate audio data representing speech of the characters. By performing such processes, the characters appear to interact with one another—such as by using voices and/or emotions that are human sounding and/or realistic—during the conversation as represented by the script. The system(s) may also use at least the generated audio data to provide content associated with the conversation to one or more users. For example, the system(s) may provide at least audio representing the speech to the user(s) such that the user(s) is able to listen to the interaction between the characters. In some examples, the system(s) may provide additional content to the user(s), such as visual content representing the characters interacting.

In some examples, the mode(s) (e.g., machine learning models, deep neural networks, language models, LLMs, VLMs, multi-modal language models, perception models, tracking models, fusion models, transformer models, diffusion models, encoder-only models, decoder-only models, encoder-decoder models, neural rendering field (NERF) models, neural networks, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure.

For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used. For example, the machine learning model(s) described herein may be used to perform translation for users who speak any number of languages to any number of other languages. As such, the game and/or other users are able to understand and communicate across languages.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used. For example, the machine learning model(s) described herein may be used to perform generate scripts for AI characters to communicate with during video conferencing applications.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers). For example, the machine learning model(s) described herein may be used to generate speech for the robot to communicate with persons/other robots in an environment.

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

Although examples may be described herein with respect to using machine learning models, such as language models, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

In some embodiments, one or more transformer engines (TEs) may be implemented. The transformer engine may use micro-tensor scaling to optimize performance and accuracy-such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches-such as NVLink Switches) and tensor cores (which enable mixed-precision computing, such as microscaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

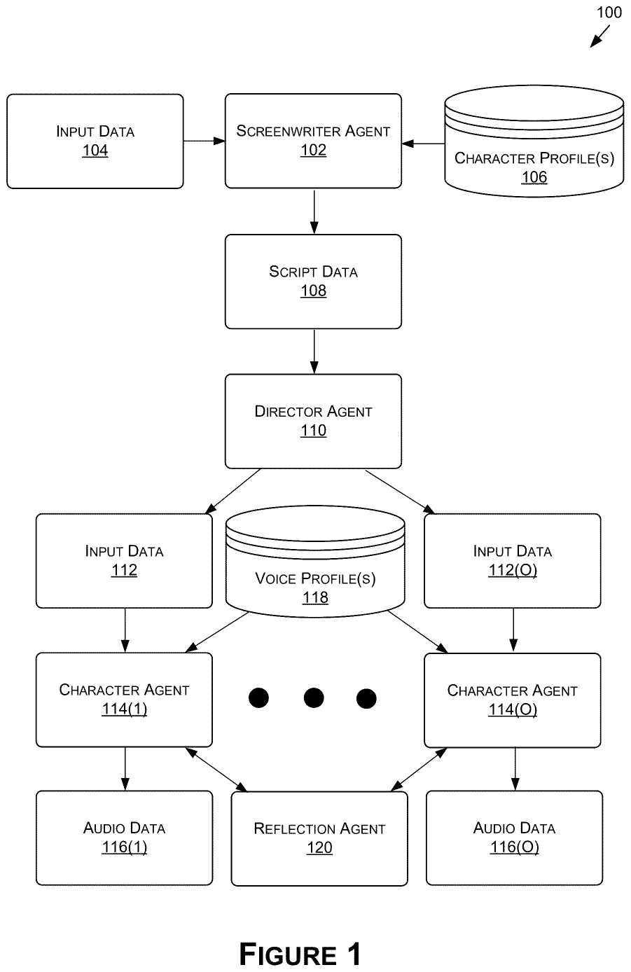

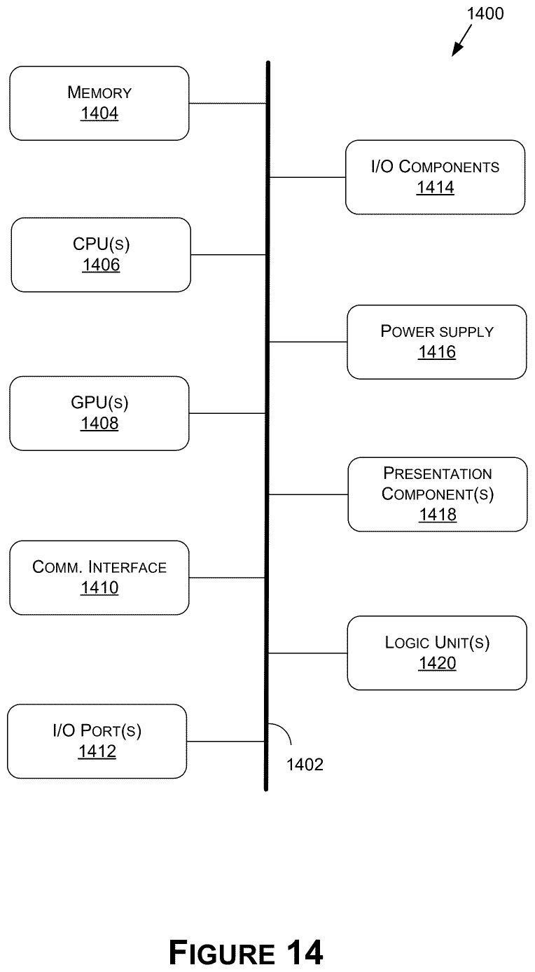

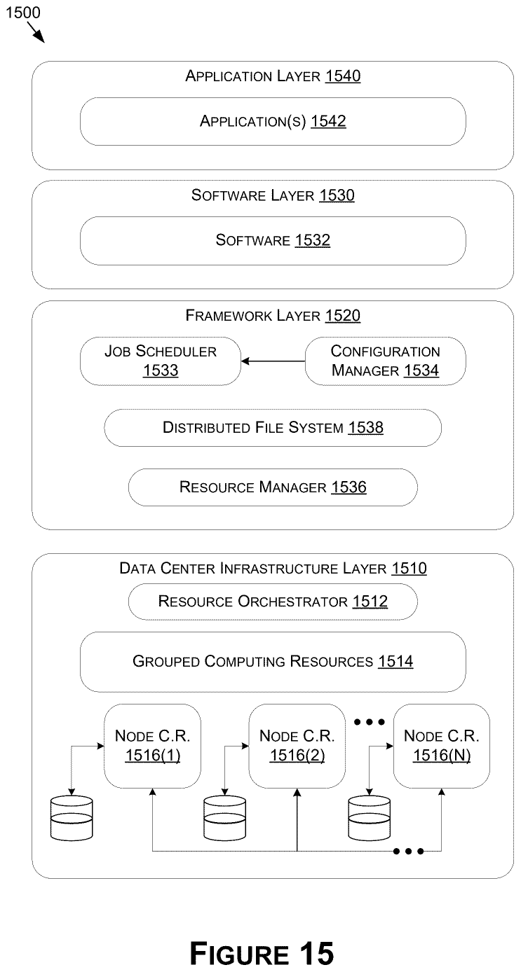

With reference to FIG. 1, FIG. 1 illustrates an example data flow diagram for a process 100 for generating audio content associated with conversations between AI agents, in accordance with some embodiments of the present disclosure. If should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example computing device 1400 of FIG. 14 and/or example data center 1500 of FIG. 15.

The process 100 may include a screenwriter agent 102 receiving at least (1) input data 104 representing inputted information for generating a conversation—such as a debate, a podcast, a discussion, a review, and/or any other type of conversation—between characters and/or (2) one or more character profiles 106 from one or more databases. As described herein, the information may include, but is not limited to, one or more topics, a number of characters, identities of the characters, roles of the characters, a plain language description, a number of scenes, one or more time thresholds for one or more of the scenes, text, audio, video data, and/or any other information that may be used to create the conversation. Additionally, a character profile 106 may include, but is not limited to, a language profile, a personality profile, and/or any other type of profile that represents traits associated with a character included in the conversation.

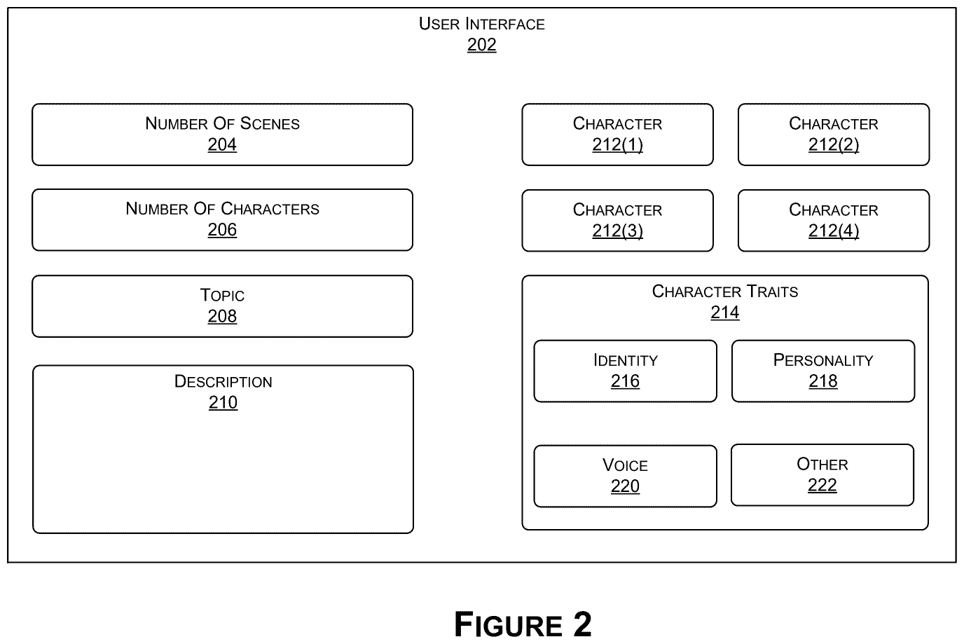

For more details, FIG. 2 illustrates an example of a user inputting information for creating a conversation between characters, in accordance with some embodiments of the present disclosure. As shown, the user may be provided with a user interface 202 that includes a number of interface elements—such as buttons, text boxes, sliders, lists, and/or the like—for inputting the information. For instance, the user interface 202 may include a first interface element for inputting a number of scenes 204 (e.g., one scene, five scenes, ten scenes, etc.) associated with the conversation. The user interface 202 may also include a second interface element for inputting a number of characters 206 (e.g., guests) to include in the conversation. Additionally, the user interface 202 may include a third interface element for inputting a topic 208 associated with the conversation. As descried herein, a topic 208 may include, but is not limited to, politics, sports, the economy, cars, books, news, movies, restaurants, vacation destinations, and/or any other type of topic that may be discussed. Furthermore, the user interface 202 may include a fourth interface element for inputting a description 210 associated with the conversation. For instance, the description 210 may include an overview of what to discuss with regard to the topic 208, instructions on how to discuss the topic 208, emotional information associated with the characters when discussing the topic 208, and/or any other information.

The user interface 202 may further allow for inputting information about the characters that are to be included in the conversation. For instance, in the example of FIG. 2, the user may have selected four characters such that the user interface 202 includes interface elements for inputting information for a first character 212(1), a second character 212(2), a third character 212(3), and a fourth character 212(4). When selecting a character, the user interface 202 may then include an additional interface element for inputting traits 214 associated with the character. As shown, the traits 214 may include at least an identity 216 of the character, a personality 218 of the character, a voice 220 of the character, and/or other information 222 (e.g., a roll, etc.) associated with the character. While the user interface 202 in the example of FIG. 2 allows the user to provide specific types of information for creating a conversation, in other example, user interfaces may allow for inputting additional and/or alternative types of information associated with creating conversations.

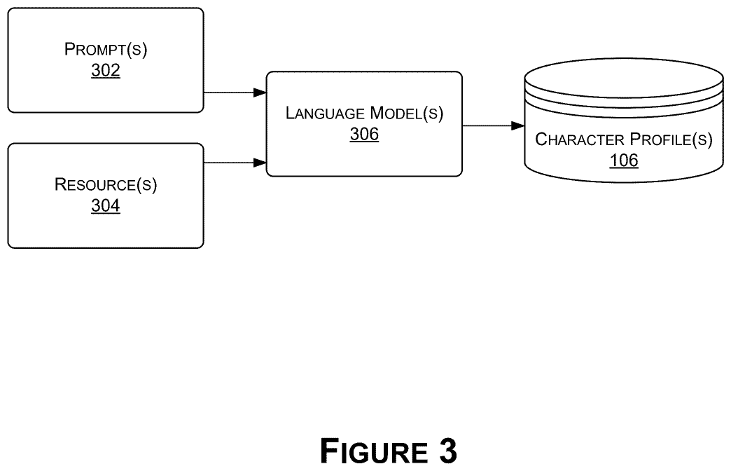

Next, FIG. 3 illustrates an example of generating the character profile(s) 106 associated with characters that may be included in a conversation, in accordance with some embodiments of the present disclosure. As shown, input data representing one or more prompts 302 and/or one or more resources 304 may be applied to one or more language models 306. As described herein, a resource 304 may include, but is not limited to, a webpage, a book, a biography, a manuscript, a document, an article, notes, and/or any other type of resource that may include information related to a character. Additionally, a prompt 302 may be associated with a specific type of information to retrieve to generate a character profile 106. For instance, a language prompt 302 may be used to retrieve information for generating a language profile 106, a personality prompt 302 may be used to retrieve information for generating a personality profile 106, and/or the like.

For more details, the language prompt 302 may be associated with retrieving and/or generating specific types of information, such as a speech pattern, a tone, a dialect, an accent, a communication style, an emotional expression, and/or any other type of language information associated with a character. Additionally, the personality prompt 302 may be associated with retrieving and/or generating other types of information, such as personality traits, behavioral patterns, emotional characteristics, motivations, features, interpersonal relations, conflict resolution, an age, a zodiac sign, and/or any other personality and/or behavioral information associated with a character. In either example, a prompt 302 may include a task to perform (e.g., the information to retrieve and/or generate), the requirements to perform the task (e.g., how to perform the analysis, how to organize the information, etc.), the formatting of the information (e.g., use sentences, break into points, etc.), the inputs (e.g., the resource(s) 304)), and/or any other information.

As shown by the example of FIG. 3, the language model(s) 306 may process the input data and generate the character profile(s) 106—such as the language profile 106, the personality profile 106, and/or any other profile—associated with the character, which may then be stored in the database(s). Additionally, in some examples, similar processes may be used to generate any number of character profiles 106 associated with any number of characters.

Referring back to the example of FIG. 1, the process 100 may include the screenwriter agent 102 using the input data 104 and/or the character profile(s) 106 to generate script data 108 representing a script associated with the conversation. As described herein, the screenwriter agent 102 may use any technique to generate the script. For instance, in some examples, the screenwriter agent 102 may generate the script by inputting data representing the inputted information and the character profile(s) 106 into one or more models—such as one or more language models (and/or any other type of model)—that process the input data and generate the script data 108 representing the script.

In some examples, the script may include the number of scenes (and/or other portions of a conversation), where an individual scene includes information and/or details for generating content related to the conversation. For instance, a scene may include at least an initial description related to what occurs during the scene, key instructions on how the scene should proceed, a duration threshold, and/or any other information. For example, an initial description for a scene may indicate that a first character is to introduce a second character. Additionally, key instructions for the scene may indicate that the first character uses humor to perform the introduction, the first character does not directly interact with the second character during the introduction, and the introduction ends with a fun remark describing the second character.

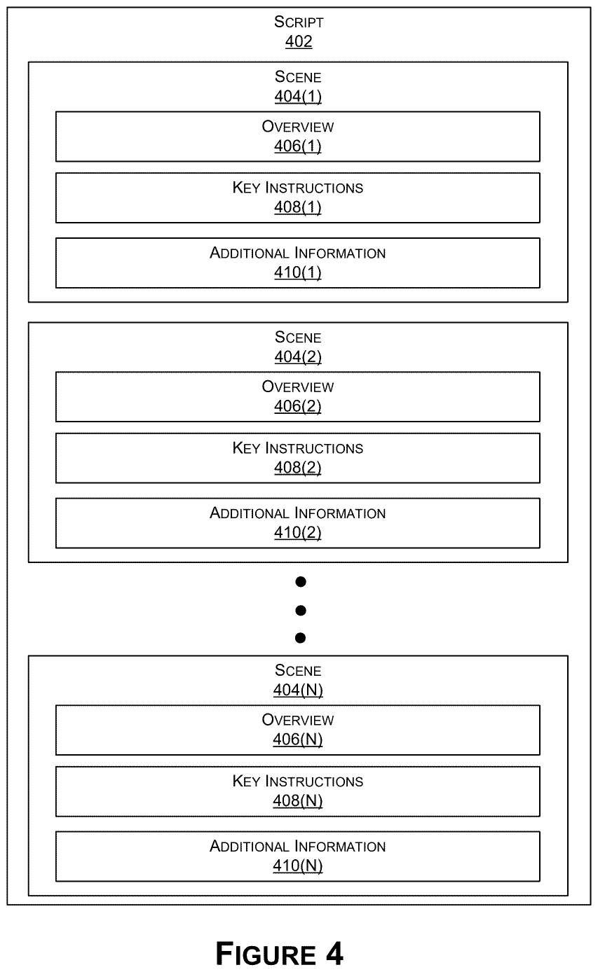

For more details, FIG. 4 illustrates an example of a script associated with a conversation between characters, in accordance with some embodiments of the present disclosure. As shown, the script 402 may include a number of scenes 404(1)-(N) (also referred to singularly as a “scene 404” or in plural as “scenes 404”) associated with a conversation. Additionally, the scenes 404 may include overviews 406(1)-(6) (also referred to singularly as an “overview 406” or in plural as “overviews 406”), key instructions 408(1)-(N) (also referred to singularly as a “key instruction 408” or in plural as “key instructions 408”), and other information 410(1)-(N) (also referred to as “other information 410”).

As described herein, the overviews 406 may include a summary of what occurs within the scenes 404, such as which characters are introduced, which characters speak, how the characters are to interact with one another (e.g., friendly, happily, in controversy, etc.), topics to be discussed, emotions of the characters, and/or any other summary details about the scenes 404. Additionally, the key instructions 408 may provide details about the conversation and/or interactions that are to occur during the scenes 404, such as questions to ask, statements to present, emotions associated with speech, emotions of characters, threshold lengths for the scenes (e.g., threshold time, number of words for speech, number of sentences for speech, number of responses to provide, etc.), and/or any other details about how the scene is to be presented. Furthermore, the other information 410 may include any other instructions, details, commands, operations, and/or the like for presenting the scenes 404 of the conversation.

For a specific example, if the conversation is associated with a dating show, the characters 212(1)-(4) may include at least a presenter and three contestants. As such, the first scene 404(1) may be associated with introducing the show such that the first overview 406(1) indicates that “The presenter introduced himself and the name of the contestants associated with the show.” Additionally, the first key instructions 408(1) may indicate that “The presenter makes humorous comments about what is going to happen in the show, “In the scene the presenter is not to interact with the contestants,” and “Keep the interactions playful and entertaining, while still engaging the audience.” In summary, the information for the first scene 404(1) may include at least an indication that the presenter is to speak, an indication of what the presenter should speak about, and an indication for how the presenter should present.

The second scene 404(2) may then be associated with the first contestant introducing himself. As such, the second overview 406(2) may indicate that “The first contestant is to introduce himself and respond to the introduction from the presenter.” Additionally, the second key instructions 408(2) may indicate that “The first contestant is to respond to the introduction provided by the presenter,” “The first contestant is then to provide additional information about the first contestant that the presenter did not provide,” “The interaction should be playful and entertaining, such as to keep the audience engaged,” and “Make sure that the first contestant closes the remarks with a funny comment about being on the show.” In summary, the information for the second scene 404(2) may include an indication that the first contestant is to speak, an indication of what the first contestant should speak about, and an indication of how the first contestant should present.

In some examples, the script 402 may then continue to include different scenes 404 associated with the show, where individual scenes correspond to a respective character—such as the presenter or a contestant—speaking based on provided instructions. While the example of FIG. 4 illustrates the script 402 as being static, in some examples, a script may be dynamic such that one or more users may provide additional information either before the conversation begins and/or during the conversation between the characters.

As described herein, the screenwriter agent 102 may generate the script 402 using various inputs, such as input data representing information describing the show. For instance, the information may indicate that the topic includes a dating show, the number of characters is four, the identities of the characters, the roles for the characters includes one presenter and three contestants, the total number of scenes 402, and/or any other information. Additionally, the screenwriter agent 102 may generate the script 402 using one or more profiles associated with the characters, such as language profiles and/or personality profiles associated with the characters. This way, the script 402 may reflect the actual traits of the characters such that the conversation appears more realistic when presented.

Referring back to the example of FIG. 1, the process 100 may include a director agent 110 processing the script data 108 to manage the conversation between the characters. For instance, the director agent 110 may process the script using one or more techniques, such as one or more models (e.g., one or more language models), one or more classifiers, one or more algorithms, one or more modules, one or more processors, and/or any other type of processing components. Based at least on the processing, the director agent 110 may identify scenes (and/or other portions) of the script that are associated with different characters and provide input data 112(1)-(O) (also referred to as “input data 112”) associated with the scenes to character agents 114(1)-(O) (also referred to singularly as a “character agent 114” or in plural as “character agents 114”). The character agents 114 may then use the input data 112 to generate audio data 116(1)-(O) (also referred to as “audio data 116”) representing speech for the characters.

For instance, in some examples, the input data 112 may represent at least text from the script, such as text from the scenes of the script that are associated with the character agents 114, character profiles 106 associated with the characters, prompts that provide instructions on how to generate speech, past interactions during the conversation, and/or any other information. The character agents 114 may then process the input data 112 using one or more language models (and/or any other type of model) that are configured to generate data representing text—such as transcripts—corresponding to the speech. Additionally, the character agents 114 may then process the text (e.g., the transcripts) using one or more additional models—such as one or more TTS models—that are configured to generate the audio data 116 representing the speech.

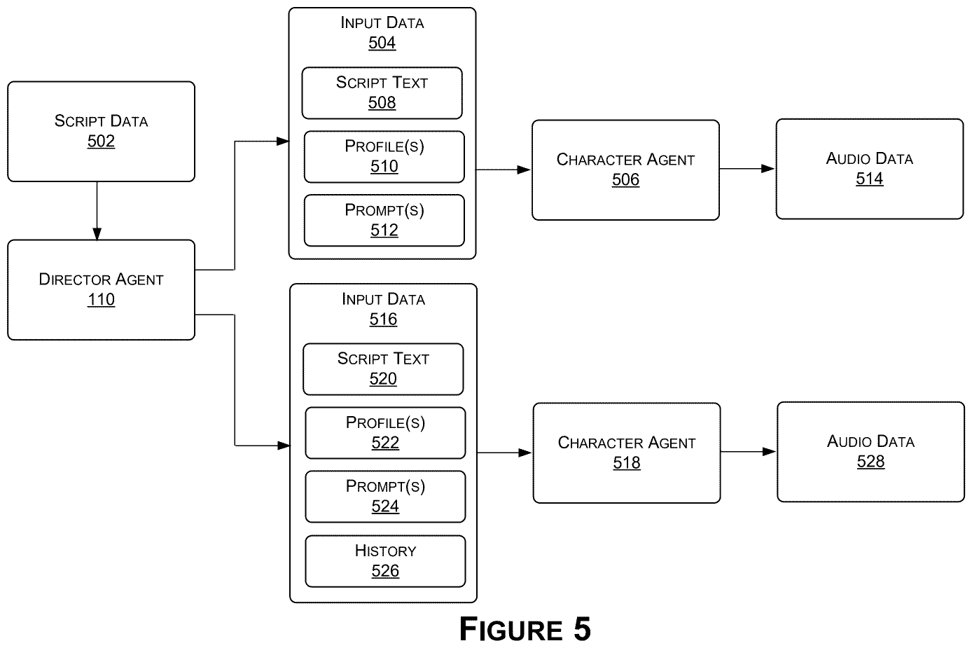

For more details, FIG. 5 illustrates an example of the director agent 110 using a script to manage a conversation between characters, in accordance with some embodiments of the present disclosure. As shown, the director agent 110 may process script data 502 representing the script 402 to manage the conversation between the presenter and the contestants. For instance, at a first time instance, the director agent 110 may analyze the script 402 to determine that the first scene 404(1) is associated with the presenter. As such, the director agent 110 may send input data 504 to a character agent 506 associated with the presenter. As shown, the input data 504 may represent at least script text 508 associated with the first scene 404(1), one or more character profiles 510 associated with the presenter, and one or more prompts 512. The character agent 506 may then process the input data 504 using one or more models—such as the language model(s) and/or the TTS model(s)—to generate audio data 514 representing speech corresponding to the first scene 404(1). For instance, the speech may be associated with the presenter introducing the show, such as “This is a dating show with a first contestant Ben, a second contestant Dave, and a third contestant Jeff.”

At a second time instance, the director agent 110 may again analyze the script 402 to determine that the second scene 404(2) is associated with the first contestant. As such, the director agent 110 may send input data 516 to a character agent 518 associated with the first contestant. As shown, the input data 516 may represent at least script text 520 associated with the second scene 404(2), one or more character profiles 522 associated with the first contestant, one or more prompts 524, and at least a portion of the speech history associated with the conversation (e.g., the speech represented by the audio data 514). The character agent 518 may then process the input data 516 using one or more models—such as the language model(s) and/or the TTS model(s)—to generate audio data 528 representing speech corresponding to the second scene 404(2). For instance, the speech may be associated with the first contestant introducing himself, such as “My name is Ben and I am a lawyer from Texas.”

The director agent 110 may then continue to perform these processes to manage the conversation by using the script 402 to send input data between the character agents associated with the presenter and the contestants. By performing such processes, the characters participating in the conversation may take turns speaking based on the input from the director agent 110 such that the characters appear to be participating in the conversation with respect to one another.

In the example of FIG. 5, the prompts 512 and 524 may be associated with generating text—such as a transcript and/or other type of dialogue—to be output by the characters in the form of speech. In some examples, a prompt may thus include one or more characteristics, such as a system that indicates the information to process to generate the text, one or more tasks to perform when analyzing the information, one or more requirements for generating the text, and the actual inputted information. For an example, the tasks(s) may provide instructions related to dialogue partner descriptions (e.g., identify characters or other objects, etc.), actual spoken utterances (e.g., quote exact words from the information, create quotes, etc.), provide inner thoughts, style connotations (e.g., analyze the style in which the character speakers, consider aspects such as tones, vocabulary, formality, and dialect, etc.), evaluating the information based on given criteria (e.g., adherence to director's prompt, align with literal value, align with context, etc.), and/or other instructions. Additionally, the requirement(s) may include the output structure (e.g., the format of the response, etc.), the dialogue type, the number of outputs, the accuracy of the outputs, the situation description (e.g., concise, without the name of the character, etc.), and/or other requirements.

In some examples, individual character agents may use unique prompts associated with generating text. For example, the prompt(s) 512 used by the character agent 506 may be different than the prompt(s) 524 used by the character agent 518 since the prompts 512 and 524 include information that is specific to each character. In some examples, the character agents may use the same prompts. For example, the prompt(s) 512 used by the character agent 506 may be the same as the prompt(s) 524 used by the character agent 518.

Referring back to the example of FIG. 1, in some examples, the process 100 may include at least a character agent 114 generating the audio data 116 to represent the speech in a voice that is associated with the character corresponding to the character agent 114. For instance, and as described herein, the user(s) may select the voice(s) associated with the character(s) when inputting the information associated with creating the conversation. As such, the character agent 114 may use a voice profile 118 representing the voice associated with the character to generate the audio data 116. In some examples, the voice profile 118 may include audio data representing user speech in the voice associated with the character. Additionally, or alternatively, in some examples, the voice profile 118 may represent multiple instances of audio data that represent multiple instances of user speech in the voice as being expressed using different emotions.

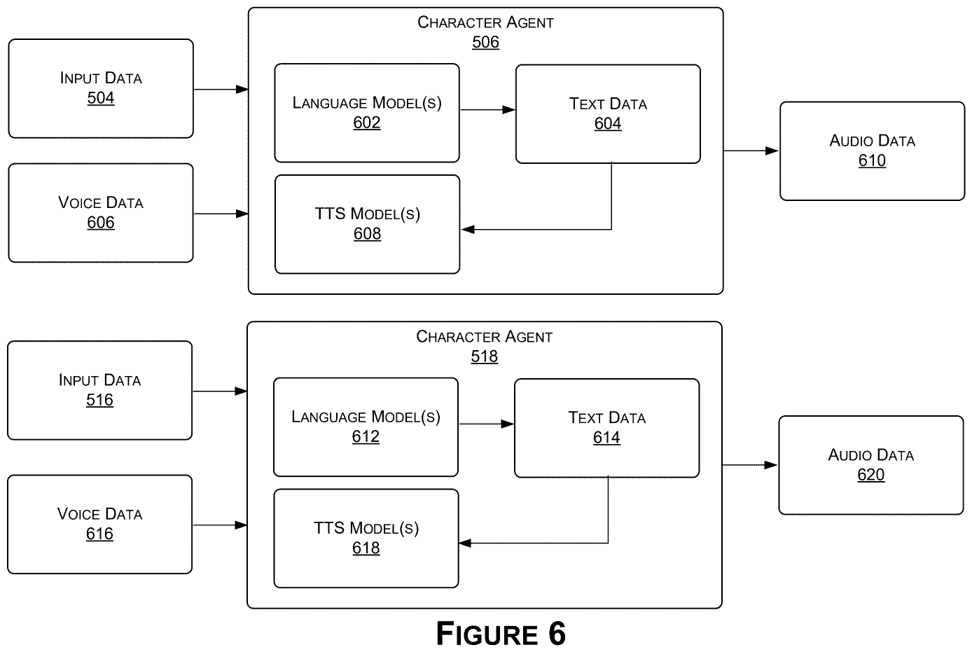

For more details, FIG. 6 illustrates a first example of using voice cloning to generate speech associated with a conversation between characters, in accordance with some embodiments of the present disclosure. As shown, the character agent 506 may process the input data 504 using one or more language models 602 that generate text data 604 representing text. For instance, the text may be associated with a transcript and/or dialogue corresponding to the speech to be output by the presenter. The character agent 506 may then process the text data 604 along with voice data 606 representing a voice associated with the presenter using one or more TTS models 608. In some examples, the voice data 606 may include stored audio data representing speech in the voice associated with the presenter. As such, based at least on processing the text data 604 and the voice data 606, the TTS model(s) 608 may generate audio data 610 (which may include the audio data 514) representing the speech to be output by the presenter and in the voice.

Additionally, the character agent 518 may process the input data 516 using one or more language models 612 (which, in some examples, may include the language model(s) 602) that generate text data 614 representing text. For instance, the text may be associated with a transcript and/or dialogue corresponding to the speech to be output by the first contestant. The character agent 518 may then process the text data 614 along with voice data 616 representing a voice associated with the first contestant using one or more TTS models 618 (which, in some examples, may include the TTS model(s) 608). In some examples, the voice data 616 may include stored audio data representing speech in the voice associated with the first contestant. As such, based at least on processing the text data 614 and the voice data 616, the TTS model(s) 618 may generate audio data 620 representing the speech to be output by the first contestant and in the voice.

As such, by performing the processes of FIG. 6, each of the characters included in the conversation—such as the presenter and the three contestants—may have unique, human voices. This may provide improvements to the conversation, such as by making the dialogue between the characters sound more realistic.

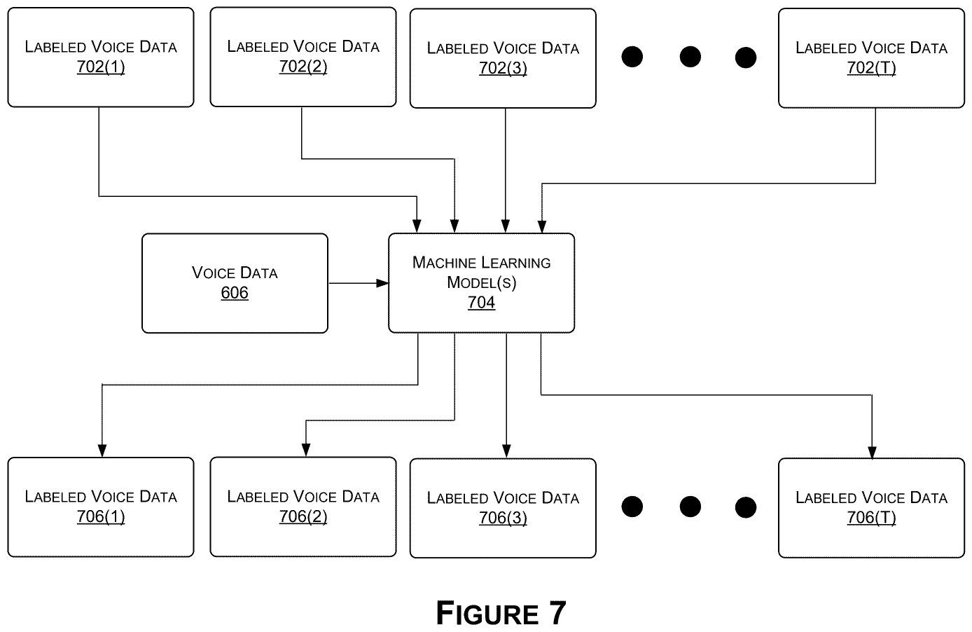

As described herein, in some examples, speech from characters may be expressed using different emotions. For instance, FIG. 7 illustrates an example of generating voice data representing a voice that is expressed using different emotions, in accordance with some embodiments of the present disclosure. In some examples, to generate the voice, a user may provide multiple speech examples where individual speech examples are expressed using different emotions. For instance, labeled voice data 702(1)-(T) (also referred to as “labeled voice data 702”) may represent instances of speech from a user that are expressed using different emotions. For example, the first labeled voice data 702(1) may include audio data representing speech from the user as expressed when angry, the second labeled voice data 702(2) may include audio data representing speech from the user as expressed when happy, the third labeled voice data 702(3) may include audio data representing speech from the user as expressed when sad, and/or so forth. In some examples, the labeled voice data 702 may then be stored in a voice profile.

Additionally, or alternatively, in some examples, a user may provide a single speech example which may then be used to generate multiple speech examples expressed using different emotions. For instance, the voice data 606 may include audio data representing speech from the user. One or more machine learning models 704 may then process the voice data 606 along with the labeled voice data 702 to generate labeled voice data 706(1)-(T) (also referred to as “labeled voice data 706”) that represents the speech of the user in the same voice, but expressed using different emotions. For example, the first labeled voice data 706(1) may include audio data representing speech from the user as expressed when angry, the second labeled voice data 706(2) may include audio data representing speech from the user as expressed when happy, the third labeled voice data 706(3) may include audio data representing speech from the user as expressed when sad, and/or so forth. In some examples, the labeled voice data 706 may then be stored in a voice profile.

As such, by performing the processes illustrated in the example of FIG. 7A, a user may provide multiple speech examples expressed using different emotions to generate a voice profile associated with the voice of the user. Alternatively, a user may provide just a single speech example that is then converted into multiple speech examples using different emotions to generate a voice profile associated with the voice of the user.

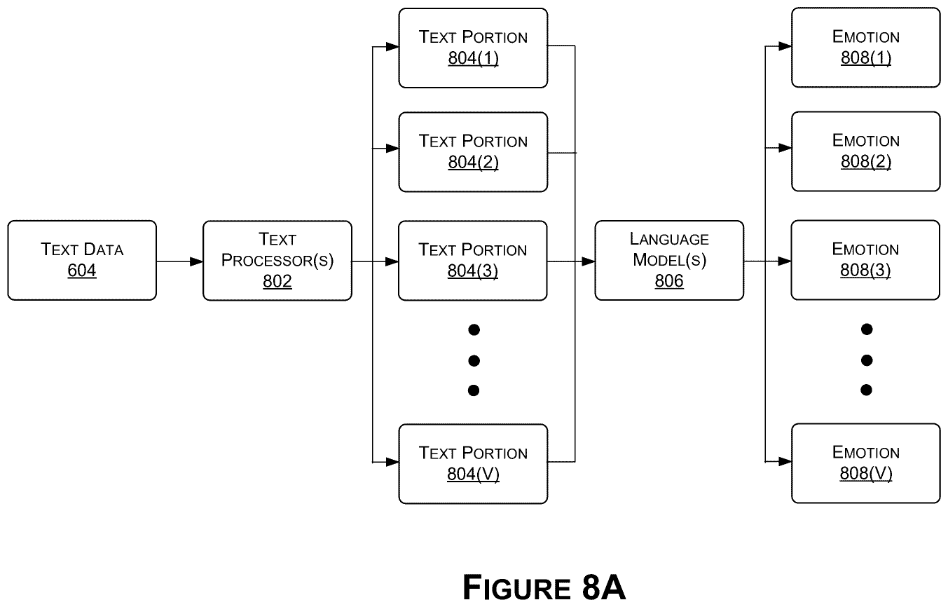

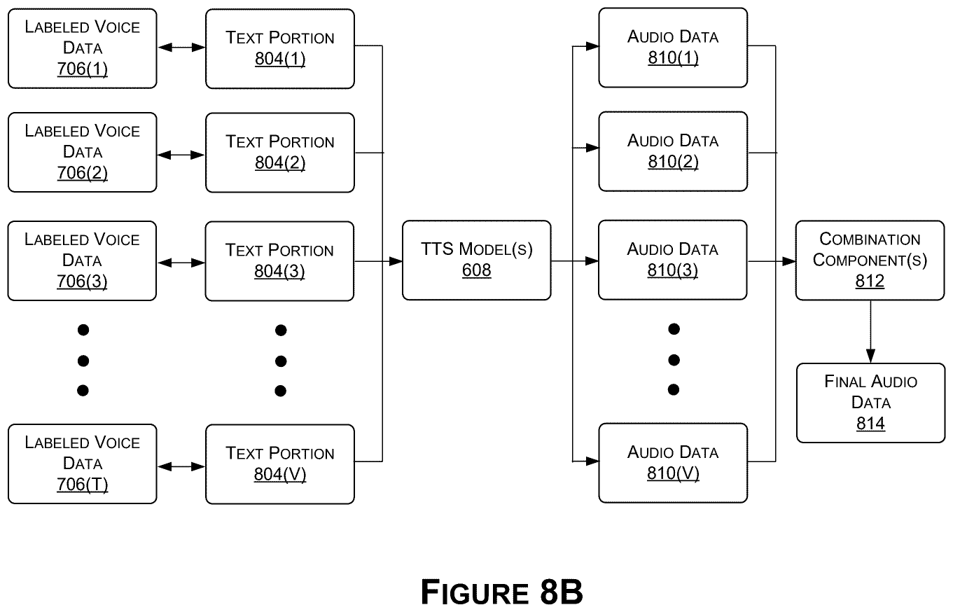

Next, FIGS. 8A-8B illustrate a second example of using voice cloning to generate speech associated with a conversation between characters, in accordance with some embodiments of the present disclosure. For instance, as illustrated by FIG. 8A, the text data 604 may be processed using one or more text processors 802—such as by performing text tokenization (and/or any other type of text processing technique)—to generate text portions 804(1)-(V) (also referred to singularly as a “text portion 804” or in plural as “text portions 804”) corresponding to the text. For instance, the text portions 804 may include letters, words, groups of words, sentences, paragraphs, and/or any other portions of the text. The text portions 804 may then be processed using one or more language models 806 that classify the text portions 804 as being associated with emotions 808(1)-(T) (also referred to singularly as an “emotion 808” or in plural as “emotions 808”). For example, the language model(s) 806 may be trained to perform emotion classification in order to classify text with emotional labels. For instance, the first text portion 808(1) may be classified as angry, the second text portion 808(2) may be classified as happy, the third text portion 808(3) may be classified as sad, and/or so forth.

Next, and as illustrated by FIG. 8B, the labeled voice data 706 corresponding to the emotions 808 may be identified. For instance, the first labeled voice data 706(1) may represent the voice expressed using the first emotion 808(1), the second labeled voice data 706(2) may represent the voice expressed using the second emotion 808(2), and/or so forth. The TTS model(s) 608 may then process the labeled voice data 706 along with the text portions 804 to generate audio data 810(1)-(V) (also referred to as “audio data 810”) representing instances of speech in the voice and expressed using the different emotions. For instance, the TTS model(s) 608 may process the first labeled voice data 706(1) along with the first text portion 804(1) to generate the first audio data 810(1) representing speech corresponding to the first text portion 804(1) and expressed using the first emotion 808(1), such as angry. Additionally, the TTS model(s) 608 may process the second labeled voice data 706(2) along with the second text portion 804(2) to generate the second audio data 810(2) representing speech corresponding to the second text portion 804(2) and expressed using the second emotion 808(2), such as happy. The TTS model(s) 608 may then continue to perform these processes to generate the other audio data 810.

One or more combination components 812 may then combine the audio data 810 to generate final audio data 814 representing an entirety of the speech corresponding to the text, where the speech is in the voice and expressed using the different emotions 808. For instance, the speech represented by the final audio data 814 may correspond to the first text portion 804(1) in the voice and expressed using the first emotion 808(1), followed by the second text portion 804(2) in the voice and expressed using the second emotion 808(2), followed by the third text portion 804(3) in the voice and expressed using the third emotion 808(3), and/or so forth. As such, by performing such processes, the speech associated with the presenter may be output in a voice corresponding to the presenter, while also being expressed using different emotions. In some examples, similar processes may be used to generate speech associated with the other characters.

Referring back to the example of FIG. 1, in some examples, the process 100 may include using a reflection agent 120 to verify that speech associated with the characters is reflective of the portions of the conversation for which the characters are speaking—such as the different scenes of the conversation—and/or are reflective of the entire conversation. For example, the reflection agent 120 may determine that text—such as a transcript and/or dialogue associated with speech—is reflective of a scene of the conversation when the text complies with the instructions provided to the character agent 114 for generating the speech. In some examples, if the reflection agent 120 determines that the text is not reflective of the scene, then the character agent 114 may use the input data 112 and/or additional data representing one or more reasons why the text is not reflective of the scene of the conversation to generate new text, such as a new transcript and/or dialogue associated with speech. This process may then continue to repeat until the reflection agent 120 determines that text reflects the scene.

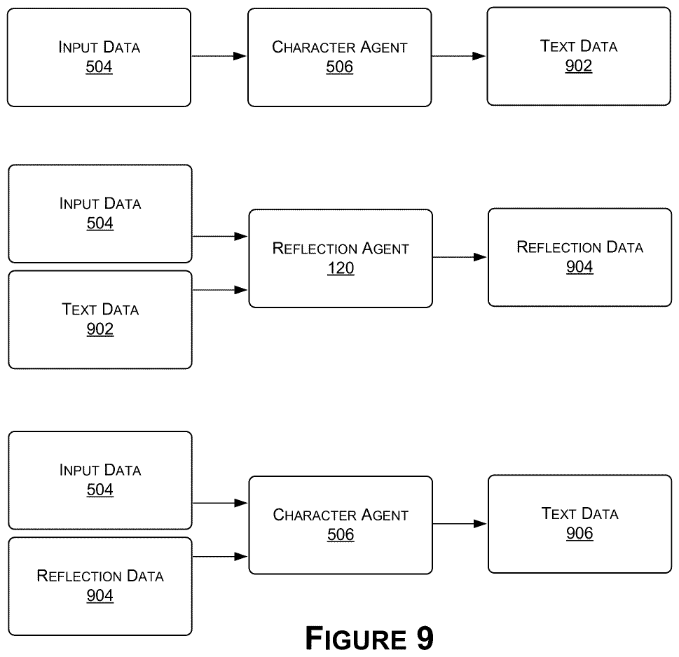

For instance, FIG. 9 illustrates an example of verifying that speech to be output by a character reflects a scene of a conversation, in accordance with some embodiments of the present disclosure. As shown, the character agent 506 may initially process the input data 504 from the example of FIG. 5 to generate text data 902 representing first text—such as a first transcript and/or a first dialogue—corresponding to speech to be output by the presenter. The reflection agent 120 may then process at least a portion of the input data 504 along with the text data 902 to determine whether the first text reflects the first scene 404(1) of the conversation. In some examples, the reflection agent 120 may use one or more models—such as one or more language models—to perform the processing. For instance, the language model(s) may process the input data 504 and the text data 902 to determine whether the first text accurately reflects the instructions represented by the input data 504.

In the example of FIG. 9, the reflection agent 120 may determine that the first text does not reflect the first scene 404(1). As such, the reflection agent 120 may generate reflection data 904 representing one or more reasons why the first text does not reflect the first scene 404(1). For example, the reflection data 904 may indicate that the first text does not reflect the correct topic, is expressed using the wrong emotion, includes incorrect information, and/or any other reason. As such, the character agent 506 may process the input data 504 along with the reflection data 904 to generate text data 906 representing second text—such as a second transcript and/or a second dialogue—corresponding to speech to be output by the presenter.

In some examples, the reflection agent 120 may then perform similar process to analyze the second text and determine that the second text does reflect the first scene 404(1). For example, the reflection agent 120 may determine that the second text does accurately follow the instructions represented by the input data 504. As such, the character agent 506 may use the text data 906 to generate the audio data representing the speech to be output by the presenter, where the speech corresponds to the second text.

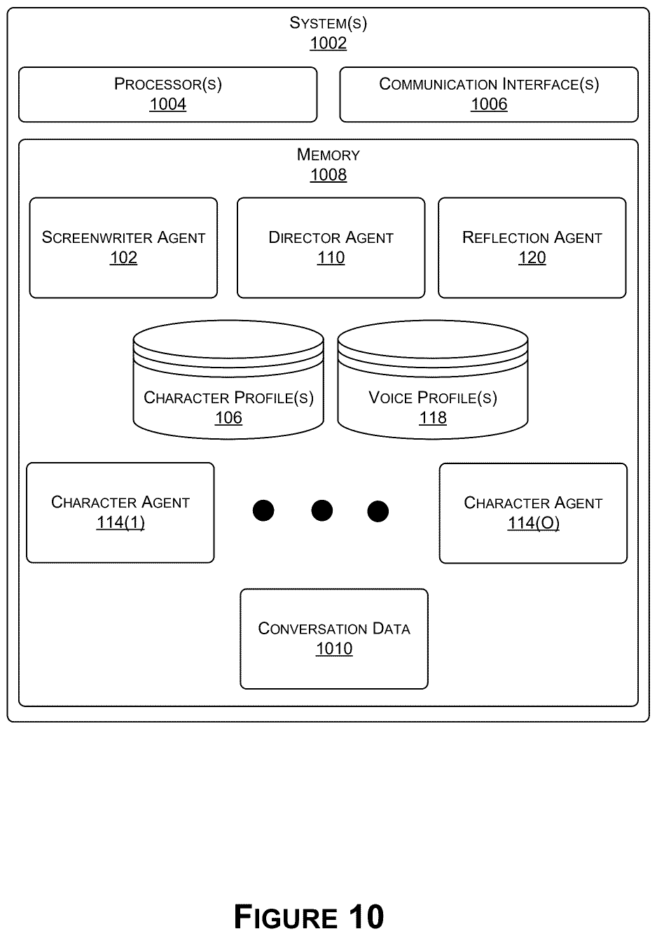

FIG. 10 illustrates an example of one or more systems 1002 that may use one or more of the processes described herein to generate conversations, in accordance with some embodiments of the present disclosure. As shown, the system(s) 1002 may include one or more processors 1004 (which may include, and/or be similar to, a CPU(s) 1406 and/or a GPU(s) 1408), one or more communication interfaces 1006 (which may include, and/or be similar to, a communication interface(s) 1410), and a memory 1008 (which may include, and/or be similar to, a memory 1404). Additionally, the memory 1008 may store agents, such as the screenwriter agent 102, the director agent 110, the character agents 114, and the reflection agent 120, the character profile(s) 106, and the voice profile(s) 118. Additionally, the processor(s) 1004 may be configured to perform one or more of the processes described herein to generate conversation data 1010 representing conversations between characters. For example, an instance of the conversation data 1010 may represent a conversation that is generated using the audio data 116.

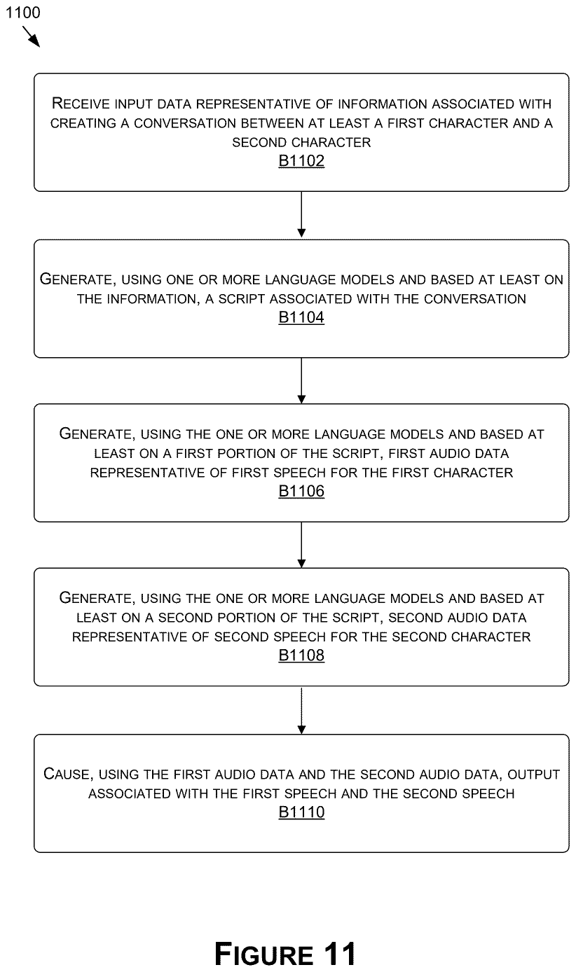

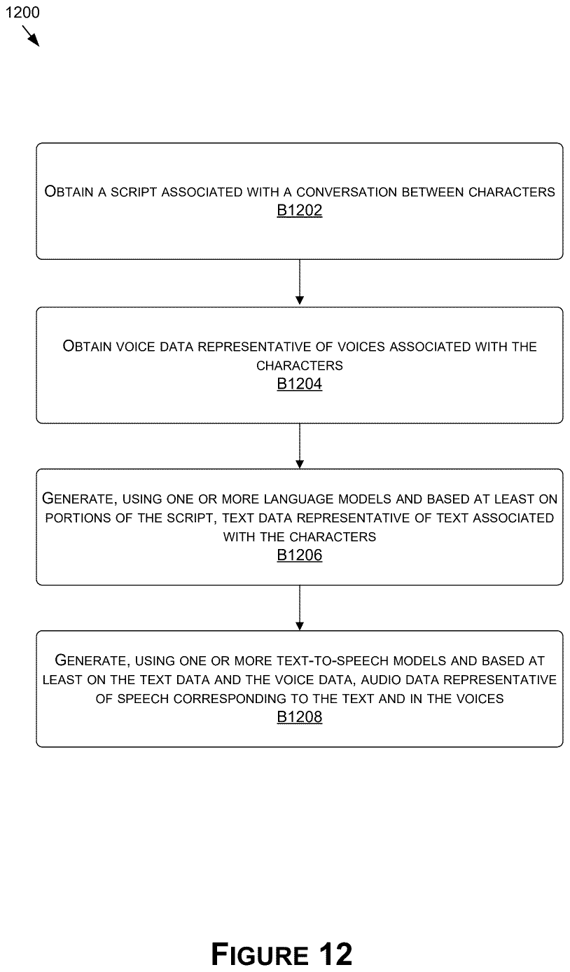

Now referring to FIGS. 11 and 12, each block of methods 1100 and 1200, described herein, comprises a computing process that may be performed using any combination of hardware, firmware, and/or software. For instance, various functions may be carried out by a processor executing instructions stored in memory. The methods 1100 and 1200 may also be embodied as computer-usable instructions stored on computer storage media. The methods 1100 and 1200 may be provided by a standalone application, a service or hosted service (standalone or in combination with another hosted service), or a plug-in to another product, to name a few. In addition, these methods 1100 and 1200 described, by way of example, with respect to FIG. 1. However, these methods 1100 and 1200 may additionally or alternatively be executed by any one system, or any combination of systems, including, but not limited to, those described herein.

FIG. 11 illustrates a flow diagram showing a method 1100 for generating audio content associated with a conversation between characters, in accordance with some embodiments of the present disclosure. The method 1100, at block B1102, may include receiving input data representative of information associated with creating a conversation between at least a first character and a second character. For instance, the screenwriter agent 102 may receive at least the input data 104 representing the information associated with creating the conversation. As described herein, the information may include, but is not limited to, one or more topics, a number of characters, identities of the characters, roles of the characters, a number of scenes, a plain language description, one or more time thresholds for one or more of the scenes, and/or any other information that may be used to create the conversation. In some examples, the screenwriter agent 102 may receive additional information, such as one or more character profiles 106 associated with the first character and/or the second character.

The method 1100, at block B1104, may include generating, using one or more language models and based at least on the information, a script associated with the conversation. For instance, the screenwriter agent 102 may process the input data 104 using the language model(s) to generate the script data 108 representing the script. As described herein, the script may include a number of scenes (and/or other portions of a conversation), where an individual scene includes information and/or details for generating content related to the conversation. For instance, a scene may include at least an initial description related to what occurs during the scene, key instructions on how the scene should proceed, a duration threshold, and/or any other information.

The method 1100, at block B1106, may include generating, using the one or more language models and based at least on a first portion of the script, first audio data representative of first speech for the first character. For instance, the director agent 110 may analyze the script to determine that the first portion of the script is related to the first character. As such, the director agent 110 may then provide a first character agent 114 associated with the first character with input data 112. As described herein, the input data 112 may represent at least text portions of the first portion of the script, the character profile(s) 106 associated with the first character, one or more prompts that provide instructions to generate speech, and/or any other information. The first character agent 114 may then process the input data 112 using the language model(s) to generate the first audio data 116 representing the first speech.

The method 1100, at block B1108, may include generating, using the one or more language models and based at least on a second portion of the script, second audio data representative of second speech for the second character. For instance, the director agent 110 may further analyze the script to determine that the second portion of the script is related to the second character. As such, the director agent 110 may then provide a second character agent 114 associated with the second character with input data 112. As described herein, the input data 112 may represent at least text portions of the second portion of the script, the character profile(s) 106 associated with the second character, one or more prompts that provide instructions to generate speech, and/or any other information. The second character agent 114 may then process the input data 112 using the language model(s) to generate the second audio data 116 representing the second speech.

The method 1100, at block B1110, may include causing, using the first audio data and the second audio data, output associated with at least the first speech and the second speech. For instance, the first audio data 116 and the second audio data 116 may be used to generate final output data representing the conversation. For example, the final output data may represent at least the first speech and the second speech. The final output data may then be used output the first speech and the second speech to one or more users.

FIG. 12 illustrates a flow diagram showing a method 1200 for generating a conversation using voice cloning for characters, in accordance with some embodiments of the present disclosure. The method 1200, at block B1202, may include obtaining a script associated with a conversation between characters. For instance, the director agent 110 may receive the script data 108 representing the script associated with the conversation. As described herein, the script may correspond to a debate, a podcast, a discussion, a review, and/or any other type of conversation for which the characters are participating. Additionally, the script may be broken into portions—such as scenes—where different characters are set to speak during the various portions.

The method 1200, at block B1204, may include obtaining voice data representative of voices associated with the characters. For instance, the character agents 114 associated with the characters may obtain the voice profiles 118 associated with the characters, where the voice profiles 118 include at least the voice data. As described herein, in some examples, a character agent 114 may receive a single instance of voice data associated with a character that merely represents the voice of the character. However, in some examples, a character agent 114 may receive multiple instances of voice data associated with a character that represents the voice of the character as expressed in different emotions.

The method 1200, at block B1206, may include generating, using one or more language models and based at least on portions of the script, text data representative of text associated with the characters. For instance, the director agent 110 may identify the different portions of the script associated with the characters and provide the respective input data 112 to the character agents 114. The character agents 114 may then process the input data using the language model(s) to generate the text data representing the text. For instance, the text may correspond to transcripts and/or dialogues that are to be output by the characters.

The method 1200, at block B1208, may include generating, using one or more text-to-speech models and based at least on the text data and the voice data, audio data representative of speech corresponding to the text and in the voices. For instance, the character agents 114 may process the text data and the voice data using the TTS model(s) to generate the audio data 116 representing the speech in the voices. As described herein, in some examples, speech for a character may be represented using just the voice while, in some examples, speech for a character may be represented using the voice as expressed in different emotions.

### EXAMPLE LANGUAGE MODELS

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

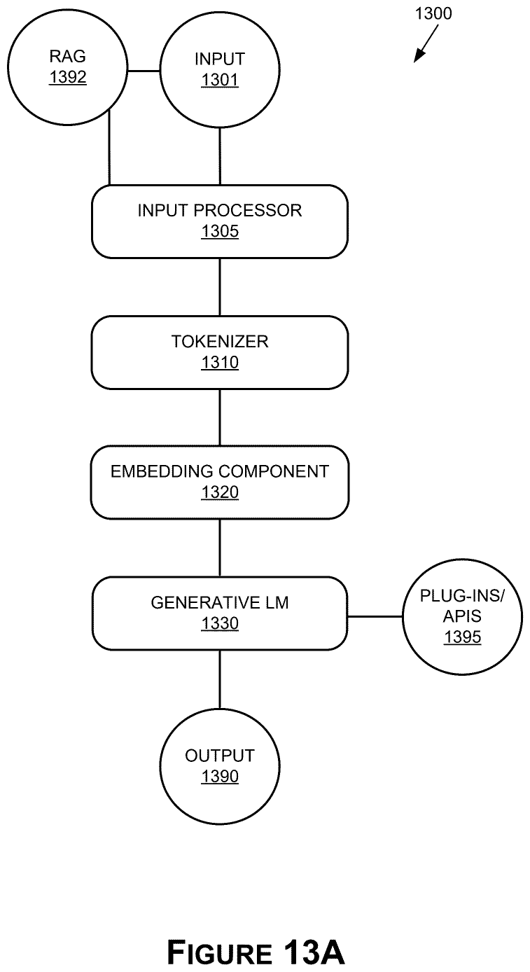

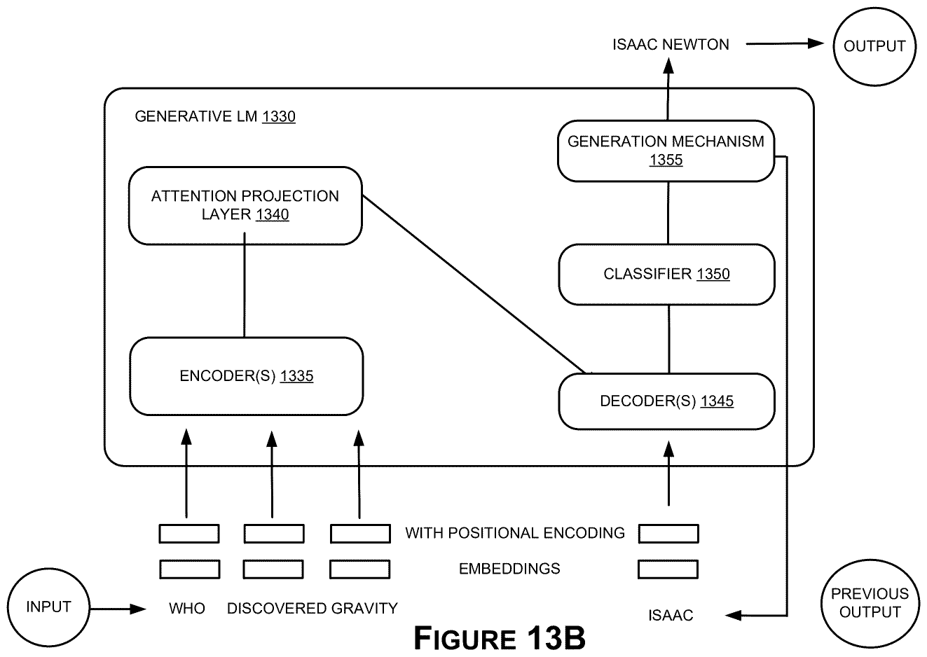

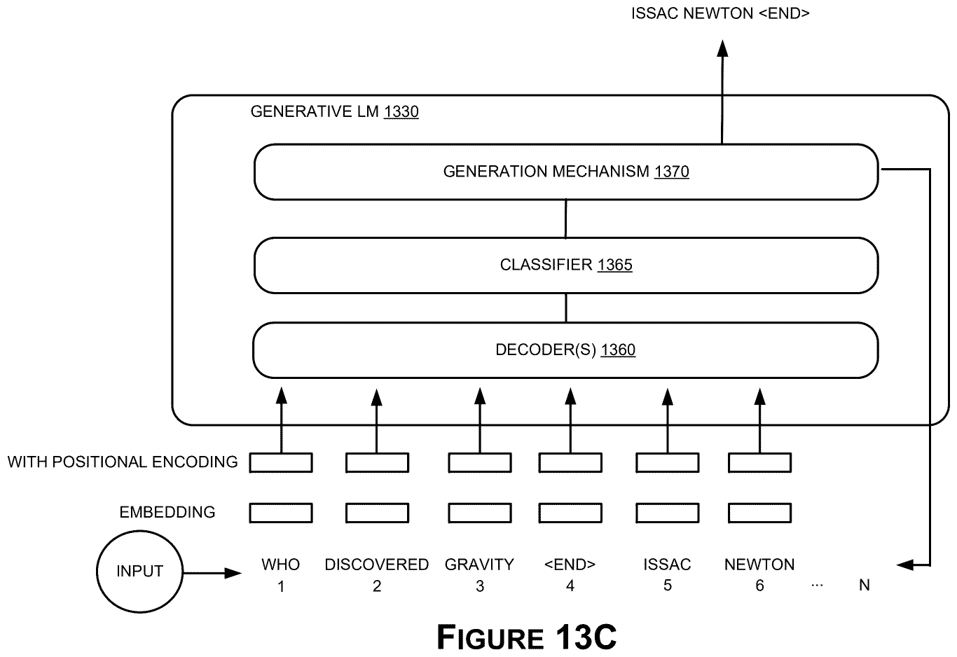

FIG. 13A is a block diagram of an example generative language model system 1300 suitable for use in implementing at least some embodiments of the present disclosure. In the example illustrated in FIG. 13A, the generative language model system 1300 includes a retrieval augmented generation (RAG) component 1392, an input processor 1305, a tokenizer 1310, an embedding component 1320, plug-ins/APIs 1395, and a generative language model (LM) 1330 (which may include an LLM, a VLM, a multi-modal LM, etc.).

At a high level, the input processor 1305 may receive an input 1301 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1330 (e.g., LLM/VLM/MMLM/etc.). In some embodiments, the input 1301 includes plain text in the form of one or more sentences, paragraphs, and/or documents. Additionally or alternatively, the input 1301 may include numerical sequences, precomputed embeddings (e.g., word or sentence embeddings), and/or structured data (e.g., in tabular formats, JSON, or XML). In some implementations in which the generative LM 1330 is capable of processing multi-modal inputs, the input 1301 may combine text (or may omit text) with image data, audio data, video data, design data, USD data, and/or other types of input data, such as but not limited to those described herein. Taking raw input text as an example, the input processor 1305 may prepare raw input text in various ways. For example, the input processor 1305 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1305 may remove stopwords to reduce noise and focus the generative LM 1330 on more meaningful content. The input processor 1305 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1392 (which may include one or more RAG models, and/or may be performed using the generative LM 1330 itself) may be used to retrieve additional information to be used as part of the input 1301 or prompt. RAG may be used to enhance the input to the LLM/VLM/MMLM/etc. with external knowledge, so that answers to specific questions or queries or requests are more relevant—such as in a case where specific knowledge is required. The RAG component 1392 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1301 may be generated using the query or input to the model (e.g., a question, a request, etc.) in addition to data retrieved using the RAG component 1392. In some embodiments, the input processor 1305 may analyze the input 1301 and communicate with the RAG component 1392 (or the RAG component 1392 may be part of the input processor 1305, in embodiments) in order to identify relevant text and/or other data to provide to the generative LM 1330 as additional context or sources of information from which to identify the response, answer, or output 1390, generally. For example, where the input indicates that the user is interested in a desired tire pressure for a particular make and model of vehicle, the RAG component 1392 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1392 may retrieve a prior stored conversation history—or at least a summary thereof—and include the prior conversation history along with the current ask/request as part of the input 1301 to the generative LM 1330.

The RAG component 1392 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1392 and the embeddings of the chunks along with the embeddings of the query may be compared to identify the most similar/related embeddings to the query, which may be supplied to the generative LM 1330 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1392 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1310 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1330 to understand morphological variations and handle out-of-vocabulary words more effectively. Character-based tokenization represents each character as a separate token, enabling the generative LM 1330 to process text at a fine-grained level. The choice of tokenization strategy may depend on factors such as the language being processed, the task at hand, and/or characteristics of the training dataset. As such, the tokenizer 1310 may convert the (e.g., processed) text into a structured format according to tokenization schema being implemented in the particular embodiment.

The embedding component 1320 may use any known embedding technique to transform discrete tokens into (e.g., dense, continuous vector) representations of semantic meaning. For example, the embedding component 1320 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1301 includes image data/video data/etc., the input processor 1301 may resize the data to a standard size compatible with format of a corresponding input channel and/or may normalize pixel values to a common range (e.g., 0 to 1) to ensure a consistent representation, and the embedding component 1320 may encode the image data using any known technique (e.g., using one or more convolutional neural networks (CNNs) to extract visual features). In some implementations in which the input 1301 includes audio data, the input processor 1301 may resample an audio file to a consistent sampling rate for uniform processing, and the embedding component 1320 may use any known technique to extract and encode audio features—such as in the form of a spectrogram (e.g., a mel-spectrogram). In some implementations in which the input 1301 includes video data, the input processor 1301 may extract frames or apply resizing to extracted frames, and the embedding component 1320 may extract features such as optical flow embeddings or video embeddings and/or may encode temporal information or sequences of frames. In some implementations in which the input 1301 includes multi-modal data, the embedding component 1320 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1330 and/or other components of the generative LM system 1300 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1320 may apply an encoded representation of the input 1301 to the generative LM 1330, and the generative LM 1330 may process the encoded representation of the input 1301 to generate an output 1390, which may include responsive text and/or other types of data.

As described herein, in some embodiments, the generative LM 1330 may be configured to access or use—or capable of accessing or using—plug-ins/APIs 1395 (which may include one or more plug-ins, application programming interfaces (APIs), databases, data stores, repositories, etc.). For example, for certain tasks or operations that the generative LM 1330 is not ideally suited for, the model may have instructions (e.g., as a result of training, and/or based on instructions in a given prompt, such as those retrieved using the RAG component 1392) to access one or more plug-ins/APIs 1395 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1395 to the plug-in/API 1395, the plug-in/API 1395 may process the information and return an answer to the generative LM 1330, and the generative LM 1330 may use the response to generate the output 1390. This process may be repeated—e.g., recursively—for any number of iterations and using any number of plug-ins/APIs 1395 until an output 1390 that addresses each ask/question/request/process/operation/etc. from the input 1301 can be generated. As such, the model(s) may not only rely on its own knowledge from training on a large dataset(s) and/or from data retrieved using the RAG component 1392, but also on the expertise or optimized nature of one or more external resources—such as the plug-ins/APIs 1395.

FIG. 13B is a block diagram of an example implementation in which the generative LM 1330 includes a transformer encoder-decoder. For example, assume input text such as “Who discovered gravity” is tokenized (e.g., by the tokenizer 1310 of FIG. 13A) into tokens such as words, and each token is encoded (e.g., by the embedding component 1320 of FIG. 913A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1335 of the generative LM 1330.

In an example implementation, the encoder(s) 1335 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1340 may convert the context vector into attention vectors (keys and values) for the decoder(s) 1345.

In an example implementation, the decoder(s) 1345 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1335, in an example transformer architecture, each token (e.g., word) flows through a separate path in the decoder(s) 1345. During a first pass, the decoder(s) 1345, a classifier 1350, and a generation mechanism 1355 may generate a first token, and the generation mechanism 1355 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1345 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1335, except that it creates its queries from the layer below it and takes the keys and values (e.g., matrix) from the output of the encoder(s) 1335.

As such, the decoder(s) 1345 may output some decoded (e.g., vector) representation of the input being applied during a particular pass. The classifier 1350 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1355 may select or sample a word or token based on a corresponding predicted probability (e.g., select the word with the highest predicted probability) and append it to the output from a previous pass, generating each word or token sequentially. The generation mechanism 1355 may repeat the process, triggering successive decoder inputs and corresponding predictions until selecting or sampling a symbol or token that represents the end of the response, at which point, the generation mechanism 1355 may output the generated response.

FIG. 13C is a block diagram of an example implementation in which the generative LM 1330 includes a decoder-only transformer architecture. For example, the decoder(s) 1360 of FIG. 13C may operate similarly as the decoder(s) 1345 of FIG. 13B except each of the decoder(s) 1360 of FIG. 13C omits the encoder-decoder self-attention layer (since there is no encoder in this implementation). As such, the decoder(s) 1360 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1360. As with the decoder(s) 1345 of FIG. 13B, each token (e.g., word) may flow through a separate path in the decoder(s) 1360, and the decoder(s) 1360, a classifier 1365, and a generation mechanism 1370 may use auto-regression to sequentially generate one token at a time until predicting a symbol or token that represents the end of the response. The classifier 1365 and the generation mechanism 1370 may operate similarly as the classifier 1350 and the generation mechanism 1355 of FIG. 13B, with the generation mechanism 1370 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### EXAMPLE COMPUTING DEVICE

FIG. 14 is a block diagram of an example computing device(s) 1400 suitable for use in implementing some embodiments of the present disclosure. Computing device 1400 may include an interconnect system 1402 that directly or indirectly couples the following devices: memory 1404, one or more central processing units (CPUs) 1406, one or more graphics processing units (GPUs) 1408, a communication interface 1410, input/output (I/O) ports 1412, input/output components 1414, a power supply 1416, one or more presentation components 1418 (e.g., display(s)), and one or more logic units 1420. In at least one embodiment, the computing device(s) 1400 may comprise one or more virtual machines (VMs), and/or any of the components thereof may comprise virtual components (e.g., virtual hardware components). For non-limiting examples, one or more of the GPUs 1408 may comprise one or more vGPUs, one or more of the CPUs 1406 may comprise one or more vCPUs, and/or one or more of the logic units 1420 may comprise one or more virtual logic units. As such, a computing device(s) 1400 may include discrete components (e.g., a full GPU dedicated to the computing device 1400), virtual components (e.g., a portion of a GPU dedicated to the computing device 1400), or a combination thereof.

Although the various blocks of FIG. 14 are shown as connected via the interconnect system 1402 with lines, this is not intended to be limiting and is for clarity only. For example, in some embodiments, a presentation component 1418, such as a display device, may be considered an I/O component 1414 (e.g., if the display is a touch screen). As another example, the CPUs 1406 and/or GPUs 1408 may include memory (e.g., the memory 1404 may be representative of a storage device in addition to the memory of the GPUs 1408, the CPUs 1406, and/or other components). In other words, the computing device of FIG. 14 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 14.

The interconnect system 1402 may represent one or more links or busses, such as an address bus, a data bus, a control bus, or a combination thereof. The interconnect system 1402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1406 may be directly connected to the memory 1404. Further, the CPU 1406 may be directly connected to the GPU 1408. Where there is direct, or point-to-point connection between components, the interconnect system 1402 may include a PCIe link to carry out the connection. In these examples, a PCI bus need not be included in the computing device 1400.

The memory 1404 may include any of a variety of computer-readable media. The computer-readable media may be any available media that may be accessed by the computing device 1400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1406 may be configured to execute at least some of the computer-readable instructions to control one or more components of the computing device 1400 to perform one or more of the methods and/or processes described herein. The CPU(s) 1406 may each include one or more cores (e.g., one, two, four, eight, twenty-eight, seventy-two, etc.) that are capable of handling a multitude of software threads simultaneously. The CPU(s) 1406 may include any type of processor, and may include different types of processors depending on the type of computing device 1400 implemented (e.g., processors with fewer cores for mobile devices and processors with more cores for servers). For example, depending on the type of computing device 1400, the processor may be an Advanced RISC Machines (ARM) processor implemented using Reduced Instruction Set Computing (RISC) or an x86 processor implemented using Complex Instruction Set Computing (CISC). The computing device 1400 may include one or more CPUs 1406 in addition to one or more microprocessors or supplementary co-processors, such as math co-processors.

In addition to or alternatively from the CPU(s) 1406, the GPU(s) 1408 may be configured to execute at least some of the computer-readable instructions to control one or more components of the computing device 1400 to perform one or more of the methods and/or processes described herein. One or more of the GPU(s) 1408 may be an integrated GPU (e.g., with one or more of the CPU(s) 1406 and/or one or more of the GPU(s) 1408 may be a discrete GPU. In embodiments, one or more of the GPU(s) 1408 may be a coprocessor of one or more of the CPU(s) 1406. The GPU(s) 1408 may be used by the computing device 1400 to render graphics (e.g., 3D graphics) or perform general purpose computations. For example, the GPU(s) 1408 may be used for General-Purpose computing on GPUs (GPGPU). The GPU(s) 1408 may include hundreds or thousands of cores that are capable of handling hundreds or thousands of software threads simultaneously. The GPU(s) 1408 may generate pixel data for output images in response to rendering commands (e.g., rendering commands from the CPU(s) 1406 received via a host interface). The GPU(s) 1408 may include graphics memory, such as display memory, for storing pixel data or any other suitable data, such as GPGPU data. The display memory may be included as part of the memory 1404. The GPU(s) 1408 may include two or more GPUs operating in parallel (e.g., via a link). The link may directly connect the GPUs (e.g., using NVLINK) or may connect the GPUs through a switch (e.g., using NVSwitch). When combined together, each GPU 1408 may generate pixel data or GPGPU data for different portions of an output or for different outputs (e.g., a first GPU for a first image and a second GPU for a simulated image). Each GPU may include its own memory, or may share memory with other GPUs.

In addition to or alternatively from the CPU(s) 1406 and/or the GPU(s) 1408, the logic unit(s) 1420 may be configured to execute at least some of the computer-readable instructions to control one or more components of the computing device 1400 to perform one or more of the methods and/or processes described herein. In embodiments, the CPU(s) 1406, the GPU(s) 1408, and/or the logic unit(s) 1420 may discretely or jointly perform any combination of the methods, processes and/or portions thereof. One or more of the logic units 1420 may be part of and/or integrated in one or more of the CPU(s) 1406 and/or the GPU(s) 1408 and/or one or more of the logic units 1420 may be discrete components or otherwise external to the CPU(s) 1406 and/or the GPU(s) 1408. In embodiments, one or more of the logic units 1420 may be a coprocessor of one or more of the CPU(s) 1406 and/or one or more of the GPU(s) 1408.

Examples of the logic unit(s) 1420 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1410 may include one or more receivers, transmitters, and/or transceivers that enable the computing device 1400 to communicate with other computing devices via an electronic communication network, included wired and/or wireless communications. The communication interface 1410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1420 and/or communication interface 1410 may include one or more data processing units (DPUs) to transmit data received over a network and/or through interconnect system 1402 directly to (e.g., a memory of) one or more GPU(s) 1408.

The I/O ports 1412 may enable the computing device 1400 to be logically coupled to other devices including the I/O components 1414, the presentation component(s) 1418, and/or other components, some of which may be built in to (e.g., integrated in) the computing device 1400. Illustrative I/O components 1414 include a microphone, mouse, keyboard, joystick, game pad, game controller, satellite dish, scanner, printer, wireless device, etc. The I/O components 1414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1400. The computing device 1400 may be include depth cameras, such as stereoscopic camera systems, infrared camera systems, RGB camera systems, touchscreen technology, and combinations of these, for gesture detection and recognition. Additionally, the computing device 1400 may include accelerometers or gyroscopes (e.g., as part of an inertia measurement unit (IMU)) that enable detection of motion. In some examples, the output of the accelerometers or gyroscopes may be used by the computing device 1400 to render immersive augmented reality or virtual reality.

The power supply 1416 may include a hard-wired power supply, a battery power supply, or a combination thereof. The power supply 1416 may provide power to the computing device 1400 to enable the components of the computing device 1400 to operate.

The presentation component(s) 1418 may include a display (e.g., a monitor, a touch screen, a television screen, a heads-up-display (HUD), other display types, or a combination thereof), speakers, and/or other presentation components. The presentation component(s) 1418 may receive data from other components (e.g., the GPU(s) 1408, the CPU(s) 1406, DPUs, etc.), and output the data (e.g., as an image, video, sound, etc.).

### EXAMPLE DATA CENTER

FIG. 15 illustrates an example data center 1500 that may be used in at least one embodiments of the present disclosure. The data center 1500 may include a data center infrastructure layer 1510, a framework layer 1520, a software layer 1530, and/or an application layer 1540.

As shown in FIG. 15, the data center infrastructure layer 1510 may include a resource orchestrator 1512, grouped computing resources 1514, and node computing resources (“node C.R.s”) 1516(1)-1516(N), where “N” represents any whole, positive integer. In at least one embodiment, node C.R.s 1516(1)-1516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1516(1)-1516(N) may correspond to a server having one or more of the above-mentioned computing resources. In addition, in some embodiments, the node C.R.s 1516(1)-15161(N) may include one or more virtual components, such as vGPUs, vCPUs, and/or the like, and/or one or more of the node C.R.s 1516(1)-1516(N) may correspond to a virtual machine (VM).

In at least one embodiment, grouped computing resources 1514 may include separate groupings of node C.R.s 1516 housed within one or more racks (not shown), or many racks housed in data centers at various geographical locations (also not shown). Separate groupings of node C.R.s 1516 within grouped computing resources 1514 may include grouped compute, network, memory or storage resources that may be configured or allocated to support one or more workloads. In at least one embodiment, several node C.R.s 1516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1512 may configure or otherwise control one or more node C.R.s 1516(1)-1516(N) and/or grouped computing resources 1514. In at least one embodiment, resource orchestrator 1512 may include a software design infrastructure (SDI) management entity for the data center 1500. The resource orchestrator 1512 may include hardware, software, or some combination thereof.

In at least one embodiment, as shown in FIG. 15, framework layer 1520 may include a job scheduler 1533, a configuration manager 1534, a resource manager 1536, and/or a distributed file system 1538. The framework layer 1520 may include a framework to support software 1532 of software layer 1530 and/or one or more application(s) 1542 of application layer 1540. The software 1532 or application(s) 1542 may respectively include web-based service software or applications, such as those provided by Amazon Web Services, Google Cloud and Microsoft Azure. The framework layer 1520 may be, but is not limited to, a type of free and open-source software web application framework such as Apache Spark™ (hereinafter “Spark”) that may utilize distributed file system 1538 for large-scale data processing (e.g., “big data”). In at least one embodiment, job scheduler 1533 may include a Spark driver to facilitate scheduling of workloads supported by various layers of data center 1500. The configuration manager 1534 may be capable of configuring different layers such as software layer 1530 and framework layer 1520 including Spark and distributed file system 1538 for supporting large-scale data processing. The resource manager 1536 may be capable of managing clustered or grouped computing resources mapped to or allocated for support of distributed file system 1538 and job scheduler 1533. In at least one embodiment, clustered or grouped computing resources may include grouped computing resource 1514 at data center infrastructure layer 1510. The resource manager 1536 may coordinate with resource orchestrator 1512 to manage these mapped or allocated computing resources.

In at least one embodiment, software 1532 included in software layer 1530 may include software used by at least portions of node C.R.s 1516(1)-1516(N), grouped computing resources 1514, and/or distributed file system 1538 of framework layer 1520. One or more types of software may include, but are not limited to, Internet web page search software, e-mail virus scan software, database software, and streaming video content software.

In at least one embodiment, application(s) 1542 included in application layer 1540 may include one or more types of applications used by at least portions of node C.R.s 1516(1)-1516(N), grouped computing resources 1514, and/or distributed file system 1538 of framework layer 1520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1534, resource manager 1536, and resource orchestrator 1512 may implement any number and type of self-modifying actions based on any amount and type of data acquired in any technically feasible fashion. Self-modifying actions may relieve a data center operator of data center 1500 from making possibly bad configuration decisions and possibly avoiding underutilized and/or poor performing portions of a data center.

The data center 1500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1500. In at least one embodiment, trained or deployed machine learning models corresponding to one or more neural networks may be used to infer or predict information using resources described above with respect to the data center 1500 by using weight parameters calculated through one or more training techniques, such as but not limited to those described herein.

In at least one embodiment, the data center 1500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1400 of FIG. 14—e.g., each device may include similar components, features, and/or functionality of the computing device(s) 1400. In addition, where backend devices (e.g., servers, NAS, etc.) are implemented, the backend devices may be included as part of a data center 1500, an example of which is described in more detail herein with respect to FIG. 15.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1400 described herein with respect to FIG. 14. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE PARAGRAPHS

A: A method comprising: receiving input data representative of information associated with creating a conversation between at least a first character and a second character; generating, using one or more language models and based at least on the information, a script associated with the conversation; generating, using the one or more language models and based at least on a first scene of the script, first audio data representative of first synthetic speech for the first character; generating, using the one or more language models and based at least on a second scene of the script, second audio data representative of second synthetic speech for the second character; and causing, using the first audio data and the second audio data, output associated with at least the first synthetic speech and the second synthetic speech.

B: The method of paragraph A, further comprising: obtaining at least one of one or more first profiles describing a first personality associated with the first character or one or more second profiles describing a second personality associated with the second character, wherein the information includes the at least one of the one or more first profiles or the one or more second profiles.

C: The method of paragraph B, further comprising at least one of: generating, using the one or more language models and based at least on one or more first resources associated with the first character, the one or more first profiles; or generating, using the one or more language models and based at least on one or more second resources associated with the second character, the one or more second profiles.

D: The method of any one of paragraphs A-C, wherein: the information indicates at least a first voice associated with the first character and a second voice associated with the second character; the generating the first audio data comprises generating, using the one or more language models and based at least on the first scene of the script and first voice data associated with the first voice, the first audio data representative of the first synthetic speech expressed using the first voice; and the generating the second audio data comprises generating, using the one or more language models and based at least on a second scene of the script and second voice data associated with the second voice, the second audio data representative of the second synthetic speech expressed using the second voice.

E: The method of any one of paragraphs A-D, wherein the generating the first audio data representative of the first synthetic speech for the first character comprises: generating, using the one or more language models and based at least on the first scene of the script, a transcript associated with the first synthetic speech; determining at least a first emotion associated with a first portion of the transcript and a second emotion associated with a second portion of the transcript; generating, using one or more text-to-speech (TTS) models and based at least on the first portion of the transcript and first voice data associated with the first emotion, a first portion the first audio data representative of a first portion of the first speech synthetic expressed using the first emotion; and generating, using the one or more TTS models and based at least on the second portion of the transcript and second audio data associated with the second emotion, a second portion the first audio data representative of a second portion of the first synthetic speech expressed using the second emotion.

F: The method of any one of paragraphs A-E, further comprising: determining, using a first agent, that the first scene of the script is associated with the first character; providing, using the first agent and to a second agent associated with the first character, at least the first scene of the script for generating the first audio data; determining, using the first agent, that the second scene of the script is associated with the second character; and providing, using the first agent and to a third agent associated with the second character, at least the second scene of the script for generating the second audio data.

G: The method of any one of paragraphs A-F, wherein the generating the second audio data is further based at least on the first audio data representative of the first synthetic speech for the first character.

H: The method of any one of paragraphs A-G, wherein the information includes at least one of: one or more topics associated with the conversation; a plain language description of the conversation; one or more identifiers associated with at least one of the first character or the second character; one or more profiles associated with at least one of the first character or the second character; one or more roles associated with at least one of the first character or the second character; a number of scenes to include in the conversation; a threshold time associated with at least one or more scenes from the number of scenes.

I: The method of any one of paragraphs A-H, wherein the generating the first audio data representative of the first synthetic speech for the first character comprises: generating, using the one or more language models and based at least on the first scene of the script, a first transcript to be output by the first character; determining, using the one or more language models and based at least on the first transcript and one or more instructions associated with the first scene, feedback associated with the first transcript; generating, using the one or more language models and based at least on the first scene of the script and the feedback, a second transcript to be output by the first character, and generating the first audio data representative of the first synthetic speech corresponding to the second transcript.

J: A system comprising: one or more processors to: obtain a script associated with a conversation between characters; generate, using one or more language models and based at least on portions of the script, output data representative of transcripts associated with the conversation; generate, using one or more talk-to-speech (TTS) models and based at least on the transcripts and voice data associated with voices for the characters, audio data representative of speech corresponding to the characters and expressed using the voices; and cause, using the audio data, output of the speech.

K: The system of paragraph J, wherein the script is obtained, at least, by: receiving input data representative of information associated with creating the conversation; and generating, using the one or more language models and based at least on the information, the script associated with the conversation between the characters.

L: The system of either paragraph J or paragraph K, wherein the one or more processors are further to: receive input data indicating the voices to use for the characters during the conversation; and obtain, based at least on the input data, the voice data from one or more databases.

M: The system of any one of paragraphs J-L, wherein the one or more processors are further to: obtaining one or more profiles describing one or more personalities associated with one or more of the characters, wherein the generating the output data representative of the transcripts is further based at least on the one or more profiles.

N: The system of paragraph M, wherein the one or more processors are further to: obtain one or more resources that includes information associated with the one or more of the characters; and generate, using the one or more language models and based at least on the one or more resources, the one or more profiles.

O: The system of any one of paragraphs J-N, wherein the one or more processors are further to: determining, using the one or more language models and based at least on the script, the portions of the script that are associated with the characters, wherein the output data representative of the transcripts is generated based at least on using the portions of the script.

P: The system of any one of paragraphs J-O, wherein at least a portion of the output data representative of the transcripts is further generated based at least on input data representative of one or more past transcripts associated with the conversation.

Q: The system of any one of paragraphs J-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

R: One or more processors comprising: processing circuitry to: generate, using a first AI agent including one or more language models and based at least on information describing a conversation between characters, a script associated with the conversation; determine, using a second AI agent including the one or more language models, that portions of the script are associated with the characters; generate, using a third AI agent including the one or more language models or one or more second language models and based at least on the portions of the script, audio data representative of speech corresponding to the characters; and cause, using the audio data, output of the speech.

S: The one or more processors of paragraph R, wherein the processing circuitry is further to: determine that the information indicates voices associated with the character; and obtain voice data associated with the voice, wherein the audio data is further generated using the voice data such that the speech is expressed in the voices.

T: The one or more processors of either paragraph R or paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

What is claimed is:

1. A method comprising:
receiving input data representative of information associated with creating a conversation between at least a first character and a second character;
generating, using one or more language models and based at least on the information, a script associated with the conversation;
generating, using the one or more language models and based at least on a first scene of the script, first audio data representative of first synthetic speech for the first character;
generating, using the one or more language models and based at least on a second scene of the script, second audio data representative of second synthetic speech for the second character; and
causing, using the first audio data and the second audio data, output associated with at least the first synthetic speech and the second synthetic speech.

2. The method of claim 1, further comprising:
obtaining at least one of one or more first profiles describing a first personality associated with the first character or one or more second profiles describing a second personality associated with the second character,
wherein the information includes the at least one of the one or more first profiles or the one or more second profiles.

3. The method of claim 2, further comprising at least one of:
generating, using the one or more language models and based at least on one or more first resources associated with the first character, the one or more first profiles; or
generating, using the one or more language models and based at least on one or more second resources associated with the second character, the one or more second profiles.

4. The method of claim 1, wherein:
the information indicates at least a first voice associated with the first character and a second voice associated with the second character;
the generating the first audio data comprises generating, using the one or more language models and based at least on the first scene of the script and first voice data associated with the first voice, the first audio data representative of the first synthetic speech expressed using the first voice; and
the generating the second audio data comprises generating, using the one or more language models and based at least on a second scene of the script and second voice data associated with the second voice, the second audio data representative of the second synthetic speech expressed using the second voice.

5. The method of claim 1, wherein the generating the first audio data representative of the first synthetic speech for the first character comprises:
generating, using the one or more language models and based at least on the first scene of the script, a transcript associated with the first synthetic speech;
determining at least a first emotion associated with a first portion of the transcript and a second emotion associated with a second portion of the transcript;
generating, using one or more text-to-speech (TTS) models and based at least on the first portion of the transcript and first voice data associated with the first emotion, a first portion the first audio data representative of a first portion of the first speech synthetic expressed using the first emotion; and
generating, using the one or more TTS models and based at least on the second portion of the transcript and second audio data associated with the second emotion, a second portion the first audio data representative of a second portion of the first synthetic speech expressed using the second emotion.

6. The method of claim 1, further comprising:
determining, using a first agent, that the first scene of the script is associated with the first character;
providing, using the first agent and to a second agent associated with the first character, at least the first scene of the script for generating the first audio data;
determining, using the first agent, that the second scene of the script is associated with the second character; and
providing, using the first agent and to a third agent associated with the second character, at least the second scene of the script for generating the second audio data.

7. The method of claim 1, wherein the generating the second audio data is further based at least on the first audio data representative of the first synthetic speech for the first character.

8. The method of claim 1, wherein the information includes at least one of:
one or more topics associated with the conversation;
a plain language description of the conversation;
one or more identifiers associated with at least one of the first character or the second character;
one or more profiles associated with at least one of the first character or the second character;
one or more roles associated with at least one of the first character or the second character;
a number of scenes to include in the conversation;
a threshold time associated with at least one or more scenes from the number of scenes.

9. The method of claim 1, wherein the generating the first audio data representative of the first synthetic speech for the first character comprises:
generating, using the one or more language models and based at least on the first scene of the script, a first transcript to be output by the first character;
determining, using the one or more language models and based at least on the first transcript and one or more instructions associated with the first scene, feedback associated with the first transcript;
generating, using the one or more language models and based at least on the first scene of the script and the feedback, a second transcript to be output by the first character, and
generating the first audio data representative of the first synthetic speech corresponding to the second transcript.

10. A system comprising:
one or more processors to:
obtain a script associated with a conversation between characters;
generate, using one or more language models and based at least on portions of the script, output data representative of transcripts associated with the conversation;
generate, using one or more talk-to-speech (TTS) models and based at least on the transcripts and voice data associated with voices for the characters, audio data representative of speech corresponding to the characters and expressed using the voices; and
cause, using the audio data, output of the speech.

11. The system of claim 10, wherein the script is obtained, at least, by:
receiving input data representative of information associated with creating the conversation; and
generating, using the one or more language models and based at least on the information, the script associated with the conversation between the characters.

12. The system of claim 10, wherein the one or more processors are further to:
receive input data indicating the voices to use for the characters during the conversation; and
obtain, based at least on the input data, the voice data from one or more databases.

13. The system of claim 10, wherein the one or more processors are further to:
obtaining one or more profiles describing one or more personalities associated with one or more of the characters,
wherein the generating the output data representative of the transcripts is further based at least on the one or more profiles.

14. The system of claim 12, wherein the one or more processors are further to:
obtain one or more resources that includes information associated with the one or more of the characters; and
generate, using the one or more language models and based at least on the one or more resources, the one or more profiles.

15. The system of claim 10, wherein the one or more processors are further to:
determining, using the one or more language models and based at least on the script, the portions of the script that are associated with the characters,
wherein the output data representative of the transcripts is generated based at least on using the portions of the script.

16. The system of claim 10, wherein at least a portion of the output data representative of the transcripts is further generated based at least on input data representative of one or more past transcripts associated with the conversation.

17. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

18. One or more processors comprising:
processing circuitry to:
generate, using a first AI agent including one or more language models and based at least on information describing a conversation between characters, a script associated with the conversation;
determine, using a second AI agent including the one or more language models, that portions of the script are associated with the characters;
generate, using a third AI agent including the one or more language models or one or more second language models and based at least on the portions of the script, audio data representative of speech corresponding to the characters; and
cause, using the audio data, output of the speech.

19. The one or more processors of claim 18, wherein the processing circuitry is further to:
determine that the information indicates voices associated with the character; and
obtain voice data associated with the voice,
wherein the audio data is further generated using the voice data such that the speech is expressed in the voices.

20. The one or more processors of claim 18, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
